(19) United States
(12) Patent Application Publication
(10) Pub. No.: US 2024/0364898 A1
(43) Pub. Date: Oct. 31, 2024

(54) METHOD, APPARATUS AND MEDIUM FOR VIDEO PROCESSING

(71) Applicant: Bytedance Inc., Los Angeles, CA (US)

(72) Inventor: Ye-Kui WANG, Los Angeles, CA (US)

(21) Appl. No.: 18/622,078

(22) Filed: Mar. 29, 2024

Related U.S. Application Data
(63) Continuation of application No. PCT/US22/77387, filed on Sep. 30, 2022.
(60) Provisional application No. 63/250,772, filed on Sep. 30, 2021.

(51) Int. Cl. H04N 19/159; H04N 19/176

(52) U.S. Cl. CPC H04N 19/159; H04N 19/176

(57) ABSTRACT

Embodiments of the present disclosure provide a solution for video processing. A method for video processing is proposed. The method comprises: performing a conversion between a target video block of a video and a bitstream of the video according to an intra profile, the intra profile specifying a constraint of disallowing use of inter prediction in the conversion.

### CROSS REFERENCE TO RELATED APPLICATIONS

This application is a continuation of International Application No. PCT/US2022/077387, filed on Sep. 30, 2022, which claims the benefit of the U.S. Provisional Application No. 63/250,772, filed Sep. 30, 2021, the contents of which are hereby incorporated herein in its entirety by reference.

### FIELD

Embodiments of the present disclosure relates generally to video coding techniques, and more particularly, to specifying decoder capabilities for versatile video coding (VVC) range extensions profiles.

### BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the JVET when the VVC project officially started. VVC is the new coding standard, targeting at 50% bitrate reduction as compared to HEVC.

The VVC standard and the associated Versatile Supplemental Enhancement Information for coded video bitstreams (VSEI) standard have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media. The latest draft of an amendment for the VVC standard includes the specification of range extensions profiles, and other aspects.

### SUMMARY

Embodiments of the present disclosure provide a solution for video processing.

In a first aspect, a method for video processing is proposed. The method comprises: performing a conversion between a target video block of a video and a bitstream of the video according to an intra profile, the intra profile specifying a constraint of disallowing use of inter prediction in the conversion. The method in accordance with the first aspect of the present disclosure improves decoder capabilities for VVC range extensions profiles.

In a second aspect, an apparatus for processing video data is proposed. The apparatus comprises a processor and a non-transitory memory with instructions thereon. The instructions upon execution by the processor, cause the processor to perform a method in accordance with the first aspect.

In a third aspect, an apparatus for processing video data is proposed. The non-transitory computer-readable storage medium stores instructions that cause a processor to perform a method in accordance with the first aspect.

In a fourth aspect, a non-transitory computer-readable recording medium is proposed. The non-transitory computer-readable recording medium stores a bitstream of a video which is generated by a method performed by a video processing apparatus. The method comprises: generating the bitstream according to an intra profile, the intra profile specifying a constraint of disallowing use of inter prediction in a conversion between a target video block of the video and the bitstream.

In a fifth aspect, another method for storing a bitstream of a video is proposed. The method comprises: generating the bitstream according to an intra profile, the intra profile specifying a constraint of disallowing use of inter prediction in a conversion between a target video block of the video and the bitstream; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system in accordance with some embodiments of the present disclosure;

FIG. 2 illustrates a block diagram that illustrates a first example video encoder in accordance with some embodiments of the present disclosure;

FIG. 3 illustrates a block diagram that illustrates an example video decoder in accordance with some embodiments of the present disclosure;

FIG. 4 illustrates a flowchart of a method for video processing in accordance with some embodiments of the present disclosure; and

FIG. 5 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

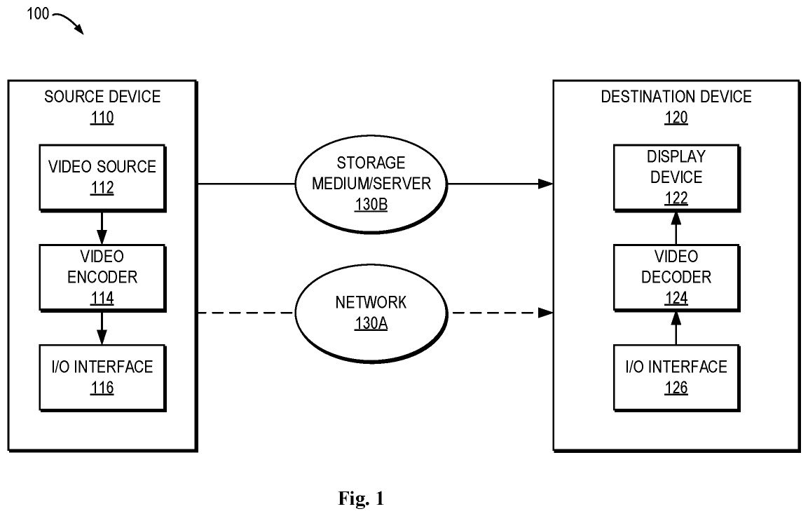

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

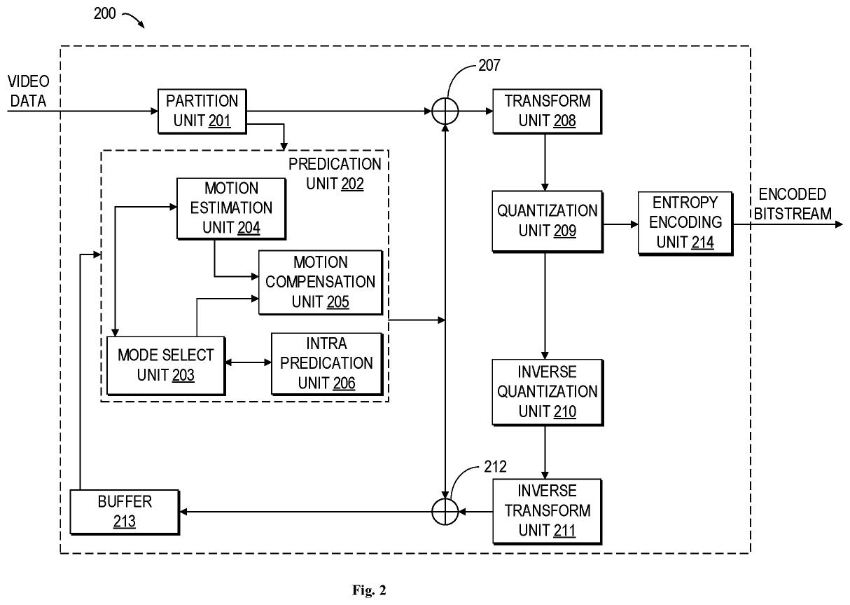

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

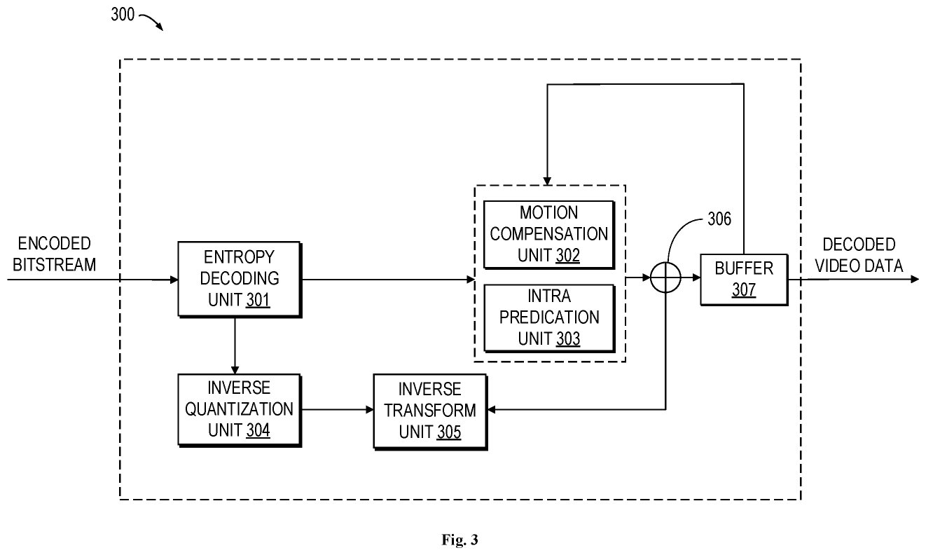

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

Detailed Solutions 1. Summary

The present disclosure is related to image/video coding technologies. Specifically, it is related to specifying decoder capabilities for VVC range extensions profiles. Embodiments of the present disclosure may be applied individually or in various combinations, for video bitstreams coded by any codec, e.g., the versatile video coding (VVC) standard.

### 2. ABBREVIATIONS

APS Adaptation Parameter Set
AU Access Unit
CLVS Coded Layer Video Sequence
CLVSS Coded Layer Video Sequence Start
CRC Cyclic Redundancy Check
CTI Colour Transform Information
CVS Coded Video Sequence
FIR Finite Impulse Response
IRAP Intra Random Access Point
NAL Network Abstraction Layer
PPS Picture Parameter Set
PU Picture Unit
RASL Random Access Skipped Leading
SAR Sample Aspect Ratio
SARI Sample Aspect Ratio Information
SEI Supplemental Enhancement Information
VCL Video Coding Layer
VSEI versatile supplemental enhancement information (Rec. ITU-T H.274| ISO/IEC 23002-7)
VUI Video Usability Information
VVC versatile video coding (Rec. ITU-T H.266| ISO/IEC 23090-3)

### 3. Background

### 3.1. Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266| ISO/IEC 23090-3) and the associated Versatile Supplemental Enhancement Information for coded video bitstreams (VSEI) standard (ITU-T H.274| ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

The latest draft of an amendment for the VVC standard is available in JVET-W2005. This amendment includes the specification of range extensions profiles, and other aspects.

### 3.2.VVC Range Extensions Profiles

The draft text for specifying the VVC range extensions profiles in JVET-W2005 is provided below.

### A3.5 Format Range Extensions Profiles

The following profiles, collectively referred to as the format range extensions profiles, are specified in this subclause:
The Main 12, Main 12 4:4:4 and Main 16 4:4:4 profiles
The Main 12 Intra, Main 12 4:4:4 Intra and Main 16 4:4:4 Intra profiles
The Main 12 Still Picture, Main 12 4:4:4 Still Picture and Main 16 4:4:4 Still Picture profiles Bitstreams conforming to the format range extensions profiles shall obey the following constraints:
Referenced SPSs shall have ptl_multilayer_enabled_flag equal to 0.
In bitstreams conforming to the Main 12 Still Picture, Main 12 4:4:4 Still Picture and Main 16 4:4:4 Still Picture profiles, the bitstream shall contain only one picture.
In bitstreams conforming to the Main 12, Main 12 4:4:4, Main 16 4:4:4, Main 12 Intra, Main 12 4:4:4 Intra, or Main 16 4:4:4 Intra profiles, general_level_idc for all values of i in active SPSs shall not be equal to 255 (which indicates level 15.5).
The tier and level constraints specified for the Main 12, Main 12 4:4:4, Main 16 4:4:4, Main 12 Intra, Main 12 4:4:4 Intra or Main 16 4:4:4 Intra profiles in subclause A.4, as applicable, shall be fulfilled.

TABLE A.1
Allowed values for syntax elements in the format range extensions profiles

| | | | | sps_extended_precision_flag |
|---|---|---|---|---|
| | | | | sps_ts_residual_coding_rice_present_in_sh_flag, |
| | | | | sps_rrc_rice_extension_flag, |
| Profile for which | sps_chroma_ | sps_bitdepth_ | sps_palette_ | sps_persistent_rice_adaptation_enabled_flag |
| constraint is specified | format_idc | minus8 | enabled_flag | sps_reverse_last_sig_coeff_enabled_flag |
| Main 12 | 0 or 1 | 0 . . . 4 | 0 | 0 |
| Main 12 4:4:4 | — | 0 . . . 4 | — | — |
| Main 16 4:4:4 | — | — | — | — |
| Main 12 Intra | 0 or 1 | 0 . . . 4 | 0 | 0 |
| Main 12 4:4:4 Intra | — | 0 . . . 4 | — | — |
| Main 16 4:4:4 Intra | — | — | — | — |
| Main 12 Still Picture | 0 or 1 | 0 . . . 4 | 0 | 0 |
| Main 12 4:4:4 Still Picture | — | 0 . . . 4 | — | — |
| Main 16 4:4:4 Still Picture | — | — | — | — |

Conformance of a bitstream to the Main 12 profile is indicated by general_profile_ide being equal to 2.
Conformance of a bitstream to the Main 12 Intra profile is indicated by general_profile_ide being equal to 10.
Conformance of a bitstream to the Main 12 Still Picture profile is indicated by general_profile_idc being equal to 66.
Conformance of a bitstream to the Main 12 4:4:4 profile is indicated by general_profile_idc being equal to 34.
Conformance of a bitstream to the Main 12 4:4:4 Intra profile is indicated by general_profile_idc being equal to 42.
Conformance of a bitstream to the Main 12 4:4:4 Still Picture profile is indicated by gen-eral_profile_idc being equal to 98.
Conformance of a bitstream to the Main 16 4:4:4 profile is indicated by general_profile_idc being equal to 36.
Conformance of a bitstream to the Main 16 4:4:4 Intra profile is indicated by general_profile_idc being equal to 44.
Conformance of a bitstream to the Main 16 4:4:4 Still Picture profile is indicated by gen-eral_profile_idc being equal to 100.

All other combinations of the syntax elements in Table A.1 with general_profile_idc equal to 2, 10, 66, 34, 42, 98, 36, 44, or 100 are reserved for future use by ITU-T| ISO/IEC. Such combinations shall not be present in bitstreams conforming to this document. However, decoders conforming to the format range extensions profiles shall allow other combinations as specified below in this subclause to occur in the bitstream.

TABLE A.2
Bitstream indications for conformance to format
range extensions profiles

| Profile | |
|---|---|
| for | |
| which the | |
| bitstream | general_lower_ |
| indicates | bit_rate_ |
| conformance | constraint_flag |
| Main 12 | 1 |
| Main 12 4:4:4 | 1 |
| Main 16 4:4:4 | 1 |
| Main 12 Intra | 0 or 1 |
| Main 12 4:4:4 Intra | 0 or 1 |
| Main 16 4:4:4 Intra | 0 or 1 |
| Main 12 Still Picture | 0 or 1 |
| Main 12 4:4:4 Still Picture | 0 or 1 |
| Main 16 4:4:4 Still Picture | 0 or 1 |

Decoders conforming to a format range extensions profile at a specific level (identified by a specific value of general_level_idc) of a specific tier (identified by a specific value of general_tier_flag) shall be capable of decoding all bitstreams and sub-layer representations for which all of the following conditions apply:
Any of the following conditions apply:
   The decoder conforms to the Main 12 4:4:4 or Main 16 4:4:4 profile, and the bitstream or sub-layer representation is indicated to conform to the Main 10 profile, or the Main 10 Still Picture profile.
   The decoder conforms to the Main 12 4:4:4 Intra, Main 16 4:4:4 Intra, Main 12 Still Picture, Main 12 4:4:4 Still Picture, or Main 16 4:4:4 Still Picture profile, and the bitstream or sub-layer representation is indicated to conform to the Main 10 Still Picture profile.
   general_profile_idc is equal to 2, 10, 66, 34, 42, 98, 36, 44, or 100 for the bitstream, and the value of each constraint flag listed in Table A. 1 is greater than or equal to the value(s) specified in the row of Table A.1 for the format range extensions profile for which the decoder conformance is evaluated.
The bitstream or sub-layer representation is indicated to conform to a tier that is lower than or equal to the specified tier.
The bitstream or sub-layer representation is indicated to conform to a level that is not level 15.5 and is lower than or equal to the specified level.

### 4. Problems

The current definitions for the VVC range extensions profiles, including the specification of decoder capabilities for these profiles, have at least the following issues:
1) For the Main 12 Intra, Main 12 4:4:4 Intra and Main 16 4:4:4 Intra profiles, there lacks a constraint to disallow the use of inter prediction.
2) The requirement of decoders conforming to the Main 12 profile to be able to decode bitstreams conforming to the Main 10 or Main 10 Still Picture profile is missing.
3) The requirement of decoders conforming to the Main 12 4:4:4 or Main 16 4:4:4 profile to be able to decode bitstreams conforming to the Main 10 4:4:4 profile or Main 10 4:4:4 Still Picture profile is is missing.
4) The requirement of decoders conforming to the Main 12 Intra profile to be able to decode bitstreams conforming to the Main 10 Still Picture profile is is missing.
5) The requirement of decoders conforming to the Main 12 4:4:4 Intra, Main 16 4:4:4 Intra, Main 12 4:4:4 Still Picture, or Main 16 4:4:4 Still Picture profile to be able to decode bitstreams conforming to the Main 10 4:4:4 Still Picture profile is is missing.
6) The following paragraph is the key part of the text specifying decoder capabilties for decoding of bitstreams conforming to the range extensions profiles:
   general_profile_idc is equal to 2, 10, 66, 34, 42, 98, 36, 44, or 100 for the bitstream, and the value of each constraint flag listed in Table A.1 is greater than or equal to the value(s) specified in the row of Table A. 1 for the format range extensions profile for which the decoder conformance is evaluated.
It has multiple problems that make the specification incorrect thus the decoder capabilities are not correctly specified:
   a) A greater value of each syntax element in Table A.1 indicates a higher capability instead of a lower capability.
   b) The following two aspects are missing in Table A.1:1) allowing more than one picture, 2) allowing inter coding.
7) The requirement of decoders conforming to the Main 12 Still Picture, Main 12 4:4:4 Still Picture, or Main 16 4:4:4 Still Picture profile to be able to decode the first picture of certain bitstreams is missing.

### 5. Details

To solve the above problems, methods as summarized below are disclosed. Embodiments of the present disclosure should be considered as examples to explain the general concepts and should not be interpreted in a narrow way. Furthermore, these embodiments can be applied individually or combined in any manner.
1) To solve problem 1, it is required that all slices in a bitstream conforming to the Main 12 Intra, Main 12 4:4:4 Intra, or Main 16 4:4:4 Intra profile shall be I slices.
   a. Alternatively, it is required that, in a bitstream conforming to the Main 12 Intra, Main 12 4:4:4 Intra, or Main 16 4:4:4 Intra profile, the value of sh_slice_type shall be equal to 2 for all slices.
   b. Alternatively, it is required that, in a bitstream conforming to the Main 12 Intra, Main 12 4:4:4 Intra, or Main 16 4:4:4 Intra profile, the value of gci_intra_only_constraint_flag shall be equal to 1.
2) To solve problem 2, the following is specified: Decoders conforming to the Main 12 profile at a specific level of a specific tier shall be capable of decoding bitstreams indicated to conform to the Main 10 profile or the Main 10 Still Picture profile, to conform to a tier that is lower than or equal to the specified tier, and to conform to a level that is not level 15.5 and is lower than or equal to the specified level.
3) To solve problem 3, the following is specified: Decoders conforming to the Main 12 4:4:4 or Main 16 4:4:4 profile at a specific level of a specific tier shall be capable of decoding bitstreams indicated to conform to the Main 10 4:4:4 or Main 10 4:4:4 Still Picture profile, to conform to a tier that is lower than or equal to the specified tier, and to conform to a level that is not level 15.5 and is lower than or equal to the specified level.
4) To solve problem 4, the following is specified: Decoders conforming to the Main 12 Intra profile at a specific level of a specific tier shall be capable of decoding bitstreams indicated to conform to the Main 10 Still Picture profile, to conform to a tier that is lower than or equal to the specified tier, and to conform to a level that is not level 15.5 and is lower than or equal to the specified level.
5) To solve problem 5, the following is specified: Decoders conforming to the Main 12 4:4:4 Intra, Main 16 4:4:4 Intra, Main 12 4:4:4 Still Picture, or Main 16 4:4:4 Still Picture profile at a specific level of a specific tier shall be capable of decoding bitstreams indicated to conform to the Main 10 4:4:4 Still Picture profile, to conform to a tier that is lower than or equal to the specified tier, and to conform to a level that is not level 15.5 and is lower than or equal to the specified level.
6) To solve problem 6, the following, with one or more of subitems 6.a.i to 6.a.ix, is specified: Decoders conforming to a format range extensions profile at a specific level (identified by a specific value of general_level_idc) of a specific tier (identified by a specific value of general_tier_flag) shall be capable of decoding all bitstreams and sublayer representations for which all of the following conditions apply:
   a. Any of the following conditions apply:
      i. The decoder conforms to the Main 12 profile, and the bitstream is indicated to conform to the Main 10, Main 10 Still Picture, Main 12, Main 12 Intra, or Main 12 Still Picture profile.
      ii. The decoder conforms to the Main 12 4:4:4 profile, and the bitstream is indicated to conform to the Main 10, Main 10 Still Picture, Main 10 4:4:4, Main 10 4:4:4 Still Picture, Main 12, Main 12 Intra, Main 12 Still Picture, Main 12 4:4:4, Main 12 4:4:4 Intra, or Main 12 4:4:4 Still Picture profile.
      iii. The decoder conforms to the Main 16 4:4:4 profile, and the bitstream is indicated to conform to Main 10, Main 10 Still Picture, Main 10 4:4:4, Main 10 4:4:4 Still Picture, or any of the format range extensions profile.
      iv. The decoder conforms to the Main 12 Intra profile, and the bitstream is indicated to conform to the Main 10 Still Picture, Main 12 Intra, or Main 12 Still Picture profile.
      v. The decoder conforms to the Main 12 4:4:4 Intra profile, and the bitstream is indicated to conform to the Main 10 Still Picture, Main 10 4:4:4 Still Picture, Main 12 Intra, Main 12 4:4:4 Intra, Main 12 Still Picture, or Main 12 4:4:4 Still Picture profile.
      vi. The decoder conforms to the Main 16 4:4:4 Intra profile, and the bitstream is indicated to conform to the Main 10 Still Picture, Main 10 4:4:4 Still Picture, Main 12 Intra, Main 12 4:4:4 Intra, Main 16 4:4:4 Intra, Main 12 Still Picture, Main 12 4:4:4 Still Picture, or Main 16 4:4:4 Still Picture profile.
      vii. The decoder conforms to the Main 12 Still Picture profile, and the bitstream is indicated to conform to the Main 10 Still Picture or Main 12 Still Picture profile.
      viii. The decoder conforms to the Main 12 4:4:4 Still Picture profile, and the bitstream is indicated to conform to the Main 10 Still Picture, Main 10 4:4:4 Still Picture, Main 12 Still Picture or Main 12 4:4:4 Still Picture profile.
      ix. The decoder conforms to the Main 16 4:4:4 Still Picture profile, and the bitstream is indicated to conform to the Main 10 Still Picture, Main 10 4:4:4 Still Picture, Main 12 Still Picture, Main 12 4:4:4 Still Picture, or Main 16 4:4:4 Still Picture profile.
   b. The bitstream is indicated to conform to a tier that is lower than or equal to the specified tier.
   c. The bitstream is indicated to conform to a level that is not level 15.5 and is lower than or equal to the specified level.
7) To solve problem 4, one or more of the following items are specified:
   a. Decoders conforming to the Main 12 Still Picture profile at a specific level of a specific tier shall also be capable of decoding of the first picture of a bitstream when both of the following conditions apply:
      i. That bitstream is indicated to conform to the Main 10, Main 12, or Main 12 Intra profile, to conform to a tier that is lower than or equal to the specified tier, and to conform to a level that is not level 15.5 and is lower than or equal to the specified level.
      ii. That picture is an IRAP picture or is a GDR picture with ph_recovery_poc_cnt equal to 0, is in an output layer, and has ph_pic_output_flag equal to 1.
   b. Decoders conforming to the Main 12 4:4:4 Still Picture profile at a specific level of a specific tier shall also be capable of decoding of the first picture of a bitstream when both of the following conditions apply:
      i. That bitstream is indicated to conform to the Main 10, Main 10 4:4:4, Main 12, Main 12 Intra, Main 12 4:4:4, or Main 12 4:4:4 Intra profile, to conform to a tier that is lower than or equal to the specified tier, and to conform to a level that is not level 15.5 and is lower than or equal to the specified level.
      ii. That picture is an IRAP picture or is a GDR picture with ph_recovery_poc_cnt equal to 0, is in an output layer, and has ph_pic_output_flag equal to 1.
   c. Decoders conforming to the Main 16 4:4:4 Still Picture profile at a specific level of a specific tier shall also be capable of decoding of the first picture of a bitstream when both of the following conditions apply:
      i. That bitstream is indicated to conform to the Main 10, Main 10 4:4:4, Main 12, Main 12 Intra, Main 12 4:4:4, Main 12 4:4:4 Intra, Main 16 4:4:4, or Main 16 4:4:4 Intra profile, to conform to a tier that is lower than or equal to the specified tier, and to conform to a level that is not level 15.5 and is lower than or equal to the specified level.
      ii. That picture is an IRAP picture or is a GDR picture with ph_recovery_poc_cnt equal to 0, is in an output layer, and has ph_pic_output_flag equal to 1.

### 6. Embodiments

Below are some example embodiments for all of the aspects according to embodiments of the present disclosure, included their subitems, summarized above in Section 5.

### 6.1. Embodiment 1

This embodiment can be applied to VVC. Most relevant parts that have been added or modified are highlighted in bold, and some of the deleted parts are highlighted in between brackets “{” and “}” and italicized. There may be some other changes that are editorial in nature and thus not highlighted.

### A3.5 Format Range Extensions Profiles

The following profiles, collectively referred to as the format range extensions profiles, are specified in this subclause:
The Main 12, Main 12 4:4:4 and Main 16 4:4:4 profiles
The Main 12 Intra, Main 12 4:4:4 Intra and Main 16 4:4:4 Intra profiles
The Main 12 Still Picture, Main 12 4:4:4 Still Picture and Main 16 4:4:4 Still Picture profiles Bitstreams conforming to the format range extensions profiles shall obey the following constraints:
Referenced SPSs shall have ptl_multilayer_enabled_flag equal to 0.
In bitstreams conforming to the Main 12 Still Picture, Main 12 4:4:4 Still Picture, or Main 16 4:4:4 Still Picture profile, the bitstream shall contain only one picture.
In a bitstream conforming to the Main 12 Intra, Main 12 4:4:4 Intra, or Main 16 4:4:4 Intra profile, the value of sh_slice_type shall be equal to 2 for all slices.
In bitstreams conforming to the Main 12, Main 12 4:4:4, Main 16 4:4:4, Main 12 Intra, Main 12 4:4:4 Intra, or Main 16 4:4:4 Intra profile, general_level_idc for all values of i in active SPSs shall not be equal to 255 (which indicates level 15.5).
The allowed values for syntax elements as specified in Error! Reference source not found, shall be followed.
The tier and level constraints specified for the Main 12, Main 12 4:4:4, Main 16 4:4:4, Main 12 Intra, Main 12 4:4:4 Intra or Main 16 4:4:4 Intra profile in subclause A.4, as applicable, shall be fulfilled.

TABLE A.1
Greatest allowed values for syntax elements in the format range extensions profiles

| | | | | sps_extended_precision_flag | |
|---|---|---|---|---|---|
| | | | | sps_ts_residual_coding_rice_ | |
| | | | | present_in_sh_flag, | |
| | | | | sps_rrc_rice_extension_flag, | |
| | | | | sps_persistent_rice_ | |
| | | | | adaptation_enabled_flag | |
| Profile for which | sps_chroma_ | sps_bitdepth_ | sps_palette_ | sps_reverse_last_sig_ | higher_bit_rate_ |
| constraint is specified | format_idc | minus8 | enabled_flag | coeff_enabled_flag | allowed_flag |
| Main 12 | 1 | 4 | 0 | 0 | 0 |
| Main 12 4:4:4 | 3 | 4 | 1 | 1 | 0 |
| Main 16 4:4:4 | 3 | 8 | 1 | 1 | 0 |
| Main 12 Intra | 1 | 4 | 0 | 0 | 1 |
| Main 12 4:4:4 Intra | 3 | 4 | 1 | 1 | 1 |
| Main 16 4:4:4 Intra | 3 | 8 | 1 | 1 | 1 |
| Main 12 Still Picture | 1 | 4 | 0 | 0 | 1 |
| Main 12 4:4:4 Still Picture | 3 | 4 | 1 | 1 | 1 |
| Main 16 4:4:4 Still Picture | 3 | 8 | 1 | 1 | 1 |

Conformance of a bitstream to the Main 12 profile is indicated by general_profile_ide being equal to 3.
Conformance of a bitstream to the Main 12 Intra profile is indicated by general_profile_ide being equal to 11.
Conformance of a bitstream to the Main 12 Still Picture profile is indicated by general_profile_idc being equal to 67.
Conformance of a bitstream to the Main 12 4:4:4 profile is indicated by general_profile_idc being equal to 35.
Conformance of a bitstream to the Main 12 4:4:4 Intra profile is indicated by general_profile_idc being equal to 43.
Conformance of a bitstream to the Main 12 4:4:4 Still Picture profile is indicated by general profile_idc being equal to 99.
Conformance of a bitstream to the Main 16 4:4:4 profile is indicated by general_profile_idc being equal to 37.
Conformance of a bitstream to the Main 16 4:4:4 Intra profile is indicated by general_profile_idc being equal to 45.
Conformance of a bitstream to the Main 16 4:4:4 Still Picture profile is indicated by gen-eral_profile_idc being equal to 101.
Decoders conforming to a format range extensions profile at a specific level (identified by a specific value of general_level_idc) of a specific tier (identified by a specific value of general_tier_flag) shall be capable of decoding all bitstreams and sublayer representations for which all of the following conditions apply:
   Any of the following conditions apply:
      {The decoder conforms to the Main 12 4:4:4 or Main 16 4:4:4 profile, and the bitstream or sub-layer representation is indicated to conform to the Main 10 profile, or the Main 10 Still Picture profile.}
      {The decoder conforms to the Main 12 4:4:4 Intra, Main 16 4:4:4 Intra, Main 12 Still Picture, Main 12 4:4:4 Still Picture, or Main 16 4:4:4 Still Picture profile, and the bitstream or sub-layer representation is indicated to conform to the Main 10 Still Picture profile.}
      The decoder conforms to the Main 12 profile, and the bitstream is indicated to conform to the Main 10, Main 10 Still Picture, Main 12, Main 12 Intra, or Main 12 Still Picture profile.
      The decoder conforms to the Main 12 4:4:4 profile, and the bitstream is indicated to conform to the Main 10, Main 10 Still Picture, Main 10 4:4:4, Main 10 4:4:4 Still Picture, Main 12, Main 12 Intra, Main 12 Still Picture, Main 12 4:4:4, Main 12 4:4:4 Intra, or Main 12 4:4:4 Still Picture profile.
      The decoder conforms to the Main 16 4:4:4 profile, and the bitstream is indicated to conform to Main 10, Main 10 Still Picture, Main 10 4:4:4, Main 10 4:4:4 Still Picture, or any of the format range extensions profile.
      The decoder conforms to the Main 12 Intra profile, and the bitstream is indicated to conform to the Main 10 Still Picture, Main 12 Intra, or Main 12 Still Picture profile.
      The decoder conforms to the Main 12 4:4:4 Intra profile, and the bitstream is indicated to conform to the Main 10 Still Picture, Main 10 4:4:4 Still Picture, Main 12 Intra, Main 12 4:4:4 Intra, Main 12 Still Picture, or Main 12 4:4:4 Still Picture profile.
      The decoder conforms to the Main 16 4:4:4 Intra profile, and the bitstream is indicated to conform to the Main 10 Still Picture, Main 10 4:4:4 Still Picture, Main 12 Intra, Main 12 4:4:4 Intra, Main 16 4:4:4 Intra, Main 12 Still Picture, Main 12 4:4:4 Still Picture, or Main 16 4:4:4 Still Picture profile.
      The decoder conforms to the Main 12 Still Picture profile, and the bitstream is indicated to conform to the Main 10 Still Picture or Main 12 Still Picture profile.
      The decoder conforms to the Main 12 4:4:4 Still Picture profile, and the bitstream is indicated to conform to the Main 10 Still Picture, Main 10 4:4:4 Still Picture, Main 12 Still Picture or Main 12 4:4:4 Still Picture profile.
      The decoder conforms to the Main 16 4:4:4 Still Picture profile, and the bitstream is indicated to conform to the Main 10 Still Picture, Main 10 4:4:4 Still Picture, Main 12 Still Picture, Main 12 4:4:4 Still Picture, or Main 16 4:4:4 Still Picture profile.
      (general_profile_ide is equal to 2, 10, 66, 34, 42, 98, 36, 44, or 100 for the bitstream, and the value of each constraint flag listed in Table A.1 is greater than or equal to the value(s) specified in the row of Table A.I for the format range extensions profile for which the decoder conformance is evaluated.}
   The bitstream is indicated to conform to a tier that is lower than or equal to the specified tier.
   The bitstream is indicated to conform to a level that is not level 15.5 and is lower than or equal to the specified level.
Decoders conforming to the Main 12 Still Picture profile at a specific level of a specific tier shall also be capable of decoding of the first picture of a bitstream when both of the following conditions apply:
   That bitstream is indicated to conform to the Main 10, Main 12, or Main 12 Intra profile, to conform to a tier that is lower than or equal to the specified tier, and to conform to a level that is not level 15.5 and is lower than or equal to the specified level.
   That picture is an IRAP picture or is a GDR picture with ph_recovery_poc_cnt equal to 0, is in an output layer, and has ph_pic_output_flag equal to 1.
Decoders conforming to the Main 12 4:4:4 Still Picture profile at a specific level of a specific tier shall also be capable of decoding of the first picture of a bitstream when both of the following conditions apply:
   That bitstream is indicated to conform to the Main 10, Main 10 4:4:4, Main 12, Main 12 Intra, Main 12 4:4:4, or Main 12 4:4:4 Intra profile, to conform to a tier that is lower than or equal to the specified tier, and to conform to a level that is not level 15.5 and is lower than or equal to the specified level.
   That picture is an IRAP picture or is a GDR picture with ph_recovery_poc_cnt equal to 0, is in an output layer, and has ph_pic_output_flag equal to 1.
Decoders conforming to the Main 16 4:4:4 Still Picture profile at a specific level of a specific tier shall also be capable of decoding of the first picture of a bitstream when both of the following conditions apply:
   That bitstream is indicated to conform to the Main 10, Main 10 4:4:4, Main 12, Main 12 Intra, Main 12 4:4:4, Main 12 4:4:4 Intra, Main 16 4:4:4, or Main 16 4:4:4 Intra profile, to conform to a tier that is lower than or equal to the specified tier, and to conform to a level that is not level 15.5 and is lower than or equal to the specified level.
   That picture is an IRAP picture or is a GDR picture with ph_recovery_poc_cnt equal to 0, is in an output layer, and has ph_pic_output_flag equal to 1.

Embodiments of the present disclosure are related to specifying decoder capabilities for VVC range extensions profiles. The embodiments can be applied individually or in various combinations, for video bitstreams coded by any codec, e.g., the VVC standard.

As used herein, the term “block” may represent a slice, a tile, a brick, a subpicture, a coding tree unit (CTU), a coding tree block (CTB), a CTU row, a CTB row, one or multiple coding units (CUs), one or multiple coding blocks (CBs), one ore multiple CTUs, one ore multiple CTBs, one or multiple Virtual Pipeline Data Units (VPDUs), a sub-region within a picture/slice/tile/brick, an inference block, and/or the like. In some embodiments, the block may comprise one or multiple samples, or one or multiple pixels in a video.

As discussed above, bitstreams of videos conforming to currently specified format range extensions profiles shall obey quite a few constraints. However, the current definitions for the VVC range extensions profiles, including the specification of decoder capabilities for these profiles, have some issues. For example, for the Main 12 Intra, Main 12 4:4:4 Intra and Main 16 4:4:4 Intra profiles, there lacks a constraint to disallow the use of inter prediction. Requirements of decoders conforming to some profiles to be able to decode bitstreams conforming to some other profiles are not specified as well. Furthermore, some decoder capabilities are not correctly specified.

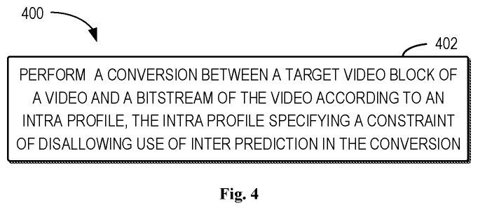

To solve at least part of these problems and other potential problems, embodiments of the present disclosure propose a solution for the VVC range extensions profiles, as will discussed with reference to FIG. 4 below. It should be understood that these embodiments are examples for explaining the general concepts and should not be interpreted in a narrow way. It is also to be understood that these embodiments can be applied individually or combined in any manner.

FIG. 4 illustrates a flowchart of a method 400 for video processing in accordance with some embodiments of the present disclosure. As shown in FIG. 4, at 402, a conversion between a target video block of a video and a bitstream of the video is performed according to an intra profile. The intra profile specifies a constraint of disallowing use of inter prediction in the conversion. For example, this constraint disallows the use of inter prediction for bitstreams conforming to the Main 12 Intra, Main 12 4:4:4 Intra, Main 16 4:4:4 Intra profile, and/or the like. In this way, more decoder capabilities for VVC range extensions profiles are specified.

Specifically, some embodiments of the present disclosure propose that all slices in a bitstream conforming to the Main 12 Intra, Main 12 4:4:4 Intra, or Main 16 4:4:4 Intra profile shall be I slices. In an embodiment, the intra profile may comprise Main 12 Intra profile, Main 12 4:4:4 Intra profile, or Main 16 4:4:4 Intra profile. In addition, slices of the video in the bitstream for the intra profile may be I slices.

In some embodiments, in the bitstream for the intra profile, a coding type of slices of the video in the bitstream may indicate a type of I slices. In this case, in the bitstream for the intra profile, a value for a slice header semantic corresponding to the coding type may be equal to two. For example, it may be required that, in a bitstream conforming to the Main 12 Intra, Main 12 4:4:4 Intra, or Main 16 4:4:4 Intra profile, the value of sh_slice_type shall be equal to 2 for all slices.

Alternatively, or in addition, in some embodiments, in the bitstream for the intra profile, a constraint flag may be set to specify that slices of the video in the bitstream are I slices. In this case, the constraint flag may be set to specify that a coding type of the slices of the video in the bitstream is a type of I slices. In some other embodiments, in the bitstream for the intra profile, a value for a general constraints information semantic corresponding to the constraint flag may equal to one. For instance, in a bitstream conforming to the Main 12 Intra, Main 12 4:4:4 Intra, or Main 16 4:4:4 Intra profile, the value of gci_intra_only_constraint_flag shall be equal to 1.

It is to be understood that, the above examples related to the Main 12 Intra, Main 12 4:4:4 Intra and Main 16 4:4:4 Intra profile are just described for example, rather than suggesting any limitation. It can be understood that other suitable profiles may also applicable.

In some embodiments, the conversion may include encoding the target video block into the bitstream. Alternatively, the conversion may include decoding the target video block from the bitstream. In other words, the method 400 can be performed at both the encoder and the decoder of the bitstream.

According to further embodiments of the present disclosure, a bitstream of a video may be stored in a non-transitory computer-readable recording medium. The bitstream is generated by a method performed by a video processing apparatus according to an intra profile. The intra profile specifies a constraint of disallowing use of inter prediction in a conversion between a target video block of the video and the bitstream.

In some embodiments, a method for storing a bitstream of a video is proposed. The bitstream is generated according to an intra profile, the intra profile specifying a constraint of disallowing use of inter prediction in a conversion between a target video block of the video and the bitstream. The bitstream is then stored in a non-transitory computer-readable recording medium.

Implementations of the present disclosure can be described in view of the following clauses, the features of which can be combined in any reasonable manner.
Clause 1. A method for video processing, comprising: performing a conversion between a target video block of a video and a bitstream of the video according to an intra profile, the intra profile specifying a constraint of disallowing use of inter prediction in the conversion.
Clause 2. The method of clause 1, wherein the intra profile comprises Main 12 Intra profile, Main 12 4:4:4 Intra profile, or Main 16 4:4:4 Intra profile.
Clause 3. The method of clause 1 or 2, wherein slices of the video in the bitstream for the intra profile are I slices.
Clause 4. The method of any of clauses 1-3, wherein in the bitstream for the intra profile, a coding type of slices of the video in the bitstream indicates a type of I slices.
Clause 5. The method of clause 4, wherein in the bitstream for the intra profile, a value for a slice header semantic corresponding to the coding type is equal to two.
Clause 6. The method of any of clauses 1-5, wherein in the bitstream for the intra profile, a constraint flag is set to specify that slices of the video in the bitstream are I slices.
Clause 7. The method of clause 6, wherein the constraint flag is set to specify that a coding type of the slices of the video in the bitstream is a type of I slices.
Clause 8. The method of clause 6 or 7, wherein in the bitstream for the intra profile, a value for a general constraints information semantic corresponding to the constraint flag is equal to one.
Clause 9. The method of any of clauses 1-8, wherein the conversion includes encoding the target video block into the bitstream.
Clause 10. The method of any of clauses 1-8, wherein the conversion includes decoding the target video block from the bitstream.
Clause 11. An apparatus for processing video data comprising a processor and a non-transitory memory with instructions thereon, wherein the instructions upon execution by the processor, cause the processor to perform a method in accordance with any of clauses 1-10.
Clause 12. A non-transitory computer-readable storage medium storing instructions that cause a processor to perform a method in accordance with any of clauses 1-10.
Clause 13. A non-transitory computer-readable recording medium storing a bitstream of a video which is generated by a method performed by a video processing apparatus, wherein the method comprises: generating the bitstream according to an intra profile, the intra profile specifying a constraint of disallowing use of inter prediction in a conversion between a target video block of the video and the bitstream.
Clause 14. A method for storing a bitstream of a video, comprising: generating the bitstream according to an intra profile, the intra profile specifying a constraint of disallowing use of inter prediction in a conversion between a target video block of the video and the bitstream; and storing the bitstream in a non-transitory computer-readable recording medium.

### Example Device

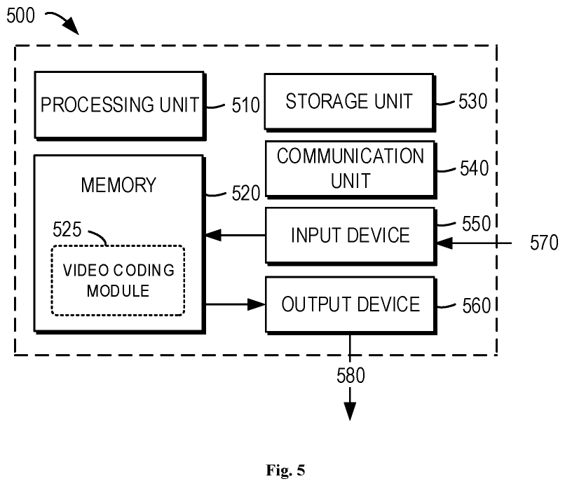

FIG. 5 illustrates a block diagram of a computing device 500 in which various embodiments of the present disclosure can be implemented. The computing device 500 may be implemented as or included in the source device 110 (or the video encoder 114 or 200) or the destination device 120 (or the video decoder 124 or 300).

It would be appreciated that the computing device 500 shown in FIG. 5 is merely for purpose of illustration, without suggesting any limitation to the functions and scopes of the embodiments of the present disclosure in any manner.

As shown in FIG. 5, the computing device 500 includes a general-purpose computing device 500. The computing device 500 may at least comprise one or more processors or processing units 510, a memory 520, a storage unit 530, one or more communication units 540, one or more input devices 550, and one or more output devices 560.

In some embodiments, the computing device 500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 500 can support any type of interface to a user (such as “wearable” circuitry and the like).

The processing unit 510 may be a physical or virtual processor and can implement various processes based on programs stored in the memory 520. In a multi-processor system, multiple processing units execute computer executable instructions in parallel so as to improve the parallel processing capability of the computing device 500. The processing unit 510 may also be referred to as a central processing unit (CPU), a microprocessor, a controller or a microcontroller.

The computing device 500 typically includes various computer storage medium. Such medium can be any medium accessible by the computing device 500, including, but not limited to, volatile and non-volatile medium, or detachable and non-detachable medium. The memory 520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 530 may be any detachable or non-detachable medium and may include a machine-readable medium such as a memory, flash memory drive, magnetic disk or another other media, which can be used for storing information and/or data and can be accessed in the computing device 500.

The computing device 500 may further include additional detachable/non-detachable, volatile/non-volatile memory medium. Although not shown in FIG. 5, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 540 communicates with a further computing device via the communication medium. In addition, the functions of the components in the computing device 500 can be implemented by a single computing cluster or multiple computing machines that can communicate via communication connections. Therefore, the computing device 500 can operate in a networked environment using a logical connection with one or more other servers, networked personal computers (PCs) or further general network nodes.

The input device 550 may be one or more of a variety of input devices, such as a mouse, keyboard, tracking ball, voice-input device, and the like. The output device 560 may be one or more of a variety of output devices, such as a display, loudspeaker, printer, and the like. By means of the communication unit 540, the computing device 500 can further communicate with one or more external devices (not shown) such as the storage devices and display device, with one or more devices enabling the user to interact with the computing device 500, or any devices (such as a network card, a modem and the like) enabling the computing device 500 to communicate with one or more other computing devices, if required. Such communication can be performed via input/output (I/O) interfaces (not shown).

In some embodiments, instead of being integrated in a single device, some or all components of the computing device 500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 500 may be used to implement video encoding/decoding in embodiments of the present disclosure. The memory 520 may include one or more video coding modules 525 having one or more program instructions. These modules are accessible and executable by the processing unit 510 to perform the functionalities of the various embodiments described herein.

In the example embodiments of performing video encoding, the input device 550 may receive video data as an input 570 to be encoded. The video data may be processed, for example, by the video coding module 525, to generate an encoded bitstream. The encoded bitstream may be provided via the output device 560 as an output 580.

In the example embodiments of performing video decoding, the input device 550 may receive an encoded bitstream as the input 570. The encoded bitstream may be processed, for example, by the video coding module 525, to generate decoded video data. The decoded video data may be provided via the output device 560 as the output 580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a target video block of a video and a bitstream of the video according to an intra profile, the intra profile specifying a constraint of disallowing use of inter prediction in the conversion.

2. The method of claim 1, wherein the intra profile comprises Main 12 Intra profile, Main 12 4:4:4 Intra profile, or Main 16 4:4:4 Intra profile; and
wherein slices of the video in the bitstream for the intra profile are I slices.

3. The method of claim 1, wherein in the bitstream for the intra profile, a coding type of slices of the video in the bitstream indicates a type of I slices.

4. The method of claim 3, wherein in the bitstream for the intra profile, a value for a slice header semantic corresponding to the coding type is equal to two.

5. The method of claim 1, wherein in the bitstream for the intra profile, a constraint flag is set to specify that slices of the video in the bitstream are I slices.

6. The method of claim 5, wherein the constraint flag is set to specify that a coding type of the slices of the video in the bitstream is a type of I slices.

7. The method of claim 5, wherein in the bitstream for the intra profile, a value for a general constraints information semantic corresponding to the constraint flag is equal to one.

8. The method of claim 1, wherein the conversion includes encoding the target video block into the bitstream, or
wherein the conversion includes decoding the target video block from the bitstream.

9. An apparatus for processing video data comprising a processor and a non-transitory memory with instructions thereon, wherein the instructions upon execution by the processor, cause the processor to perform acts comprising:
performing a conversion between a target video block of a video and a bitstream of the video according to an intra profile, the intra profile specifying a constraint of disallowing use of inter prediction in the conversion.

10. The apparatus of claim 9, wherein the intra profile comprises Main 12 Intra profile, Main 12 4:4:4 Intra profile, or Main 16 4:4:4 Intra profile; and
wherein slices of the video in the bitstream for the intra profile are I slices.

11. The apparatus of claim 9, wherein in the bitstream for the intra profile, a coding type of slices of the video in the bitstream indicates a type of I slices.

12. The apparatus of claim 11, wherein in the bitstream for the intra profile, a value for a slice header semantic corresponding to the coding type is equal to two.

13. The apparatus of claim 9, wherein in the bitstream for the intra profile, a constraint flag is set to specify that slices of the video in the bitstream are I slices.

14. The apparatus of claim 13, wherein the constraint flag is set to specify that a coding type of the slices of the video in the bitstream is a type of I slices.

15. The apparatus of claim 14, wherein in the bitstream for the intra profile, a value for a general constraints information semantic corresponding to the constraint flag is equal to one.

16. The apparatus of claim 9, wherein the conversion includes encoding the target video block into the bitstream, or
wherein the conversion includes decoding the target video block from the bitstream.

17. A non-transitory computer-readable storage medium storing instructions that cause a processor to perform acts comprising:
performing a conversion between a target video block of a video and a bitstream of the video according to an intra profile, the intra profile specifying a constraint of disallowing use of inter prediction in the conversion.

18. The apparatus of claim 17, wherein the intra profile comprises Main 12 Intra profile, Main 12 4:4:4 Intra profile, or Main 16 4:4:4 Intra profile; and
wherein slices of the video in the bitstream for the intra profile are I slices.

19. A non-transitory computer-readable recording medium storing a bitstream of a video which is generated by a method performed by a video processing apparatus, wherein the method comprises:
generating the bitstream according to an intra profile, the intra profile specifying a constraint of disallowing use of inter prediction in a conversion between a target video block of the video and the bitstream.

20. The non-transitory computer-readable recording medium of claim 19, wherein the intra profile comprises Main 12 Intra profile, Main 12 4:4:4 Intra profile, or Main 16 4:4:4 Intra profile; and
wherein slices of the video in the bitstream for the intra profile are I slices.
